(19) United States
(12) Patent Application Publication
(10) Pub. No.: US 2021/0078308 A1
(43) Pub. Date: Mar. 18, 2021

(54) PEARL PAPER AND METHOD FOR MANUFACTURING THE SAME

(71) Applicant: NAN YA PLASTICS CORPORATION, Taipei (TW)

(72) Inventors: TE-CHAO LIAO, TAIPEI (TW); CHUN-CHE TSAO, TAIPEI (TW); Chen-Ho Lai, TAIPEI (TW)

(21) Appl. No.: 16/790,942

(22) Filed: Feb. 14, 2020

(30) Foreign Application Priority Data
Sep. 12, 2019 (TW) 108133111

(51) Int. Cl. B32B 27/08; B32B 27/32; B32B 27/20; B29C 48/21; B29C 48/00

(52) U.S. Cl. CPC B32B 27/08; B32B 27/32; B32B 27/20; B29C 48/21; B29C 48/022; B32B 2250/03; B29K 2023/12; B32B 2250/40; B32B 2264/0278; B32B 2307/5825; B32B 2307/54; B32B 2554/00; B32B 2250/246

(57) ABSTRACT

A pearl paper and a method for manufacturing the same are provided. The pearl paper includes a first surface layer, a second surface layer, and a lightweight layer. The lightweight layer is disposed between the first surface layer and the second surface layer. The first surface layer is a polypropylene layer. The second surface layer is a polypropylene layer. The lightweight layer has a continuous phase part and a dispersed phase part. A material of the continuous phase part contains polypropylene and a material of the polymer dispersed phase part contains polyester.

### CROSS-REFERENCE TO RELATED PATENT APPLICATION

This application claims the benefit of priority to Taiwan Patent Application No. 108133111, filed on Sep. 12, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a pearl paper and a method for manufacturing the same, and more particularly to a pearl paper, without adding a foaming agent and inorganic metal fillers, and a method for manufacturing the same.

### BACKGROUND OF THE DISCLOSURE

A pearl paper is a synthetic paper which is manufactured from petroleum synthetic resin. In comparison with normal paper made of wood-pulp, the pearl paper has a better water-proof property, a higher tearing strength, and a smoother surface. However, a conventional pearl paper is usually made of polypropylene, such that a density of the conventional pearl paper is high. The conventional pearl paper does not possess a lightweight property.

An appropriate amount of inorganic metal fillers, such as calcium carbonate or calcium silicate, is added to a polypropylene raw material, so that the density of the conventional pearl paper can be decreased. Specifically, when the polypropylene raw material is extended in a uniaxial extension process or a biaxial extension process, some holes are formed between the polypropylene raw material and the inorganic metal filler due to irregular shapes of the inorganic metal filler. Therefore, the density of the conventional pearl paper can be decreased without adding any foaming agent. However, some surficial holes are also formed on the surface of the conventional pearl paper due to an addition of the inorganic metal filler, and as a result, a surface smoothness of the conventional pearl paper is decreased. In addition, solvents used in subsequent processes may permeate into those surficial holes, causing a deformation and degradation of a quality of the conventional pearl paper. Accordingly, subsequent applications of the conventional pearl paper are limited.

Moreover, after being used for a long period of time, the inorganic metal filler may fall off from the pearl paper and produces dust, which may result in obstacles in subsequent printing processes. Dust will roughen the surface of the pearl paper and lower the quality of the pearl paper. Therefore, the conventional pearl paper needs to be improved.

### SUMMARY OF THE DISCLOSURE

In response to the above-referenced technical inadequacies, the present disclosure provides a pearl paper and a method for manufacturing the pearl paper.

In one aspect, the present disclosure provides the pearl paper. The pearl paper includes a first surface layer, a second surface layer, and a lightweight layer. The first surface layer is a polypropylene layer. The second surface layer is disposed on the first surface layer. The second surface layer is a polypropylene layer. The lightweight layer is disposed between the first surface layer and the second surface layer. The lightweight layer includes a continuous phase part and a dispersed phase part. A material of the continuous phase part contains polypropylene, and a material of the dispersed phase part contains polyester.

In certain embodiments, the lightweight layer includes 100 parts by weight of polypropylene and 3 to 15 parts by weight of polyester.

In certain embodiments, a melting point of the material of the dispersed phase part is higher than a melting point of the material of the continuous phase part by at least 20° C.

In certain embodiments, a ratio of a thickness of the lightweight layer to a thickness of the first surface layer is 7 to 20, and a ratio of the thickness of the lightweight layer to a thickness of the second surface layer is 7 to 20. In certain embodiments, a density of the pearl paper ranges from 0.4 g/cm³ to 0.6 g/cm³.

In certain embodiments, a thickness of the first surface layer ranges from 5 μm to 10 μm, and a thickness of the second surface layer ranges from 5 μm to 10 μm.

In certain embodiments, a thickness of the lightweight layer ranges from 70 μm to 100 μm.

In certain embodiments, the first surface layer includes 100 parts by weight of polypropylene and 1 to 5 parts by weight of an anti-block agent.

In certain embodiments, the second surface layer includes 35 parts by weight of polypropylene, 1 to 5 parts by weight of an anti-block agent, 10 to 20 parts by weight of a white pigment, and 65 to 85 parts by weight of a matte agent.

In certain embodiments, the pearl paper has a tearing strength of 6.0 MPa to 8.0 MPa along a machine direction (MD) and a tearing strength of 8.5 MPa to 10.5 MPa along a cross direction (CD).

In certain embodiments, the pearl paper has a tensile strength of 65 MPa to 75 MPa along a machine direction and a tensile strength of 110 MPa to 130 MPa along a cross direction.

In certain embodiments, the pearl paper has an elongation percent of 90% to 110% along a machine direction and an elongation percent of 20% to 30% along a cross direction.

In certain embodiments, an average size of the dispersed phase part ranges from 1 μm to 2 μm.

In another aspect, the present disclosure provides the method for manufacturing the pearl paper including the following steps. A first plastic masterbatch and a second plastic masterbatch are provided. The first plastic masterbatch includes polypropylene and polyester. The second plastic masterbatch includes polypropylene. The first plastic masterbatch and the second plastic masterbatch are used to form a laminate structure by co-extrusion. The laminate structure includes a first surface layer, a second surface layer, and a lightweight layer. The lightweight layer is disposed between the first surface layer and the second surface layer. The lightweight layer is formed from the first plastic masterbatch. The lightweight layer includes a continuous phase part and a dispersed phase part. A material of the continuous phase part includes polypropylene and a material of the dispersed phase part includes polyester. The first surface layer and the second surface layer are formed from the second plastic masterbatch.

In certain embodiments, the lightweight layer is free of inorganic metal fillers.

Therefore, the pearl paper and the method for manufacturing the same provided by the present disclosure have technical features of “the lightweight layer includes a continuous phase part and a dispersed phase part”, “the material of the continuous phase part contains polypropylene”, and “the material of the dispersed phase part contains polyester”, so as to decrease a density of the pearl paper for possessing a lightweight property.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a cross-sectional view of a pearl paper of the present disclosure.

FIG. 2 is a flowchart of a method for manufacturing the pearl paper of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure provides a pearl paper and a method for manufacturing the same involving the pearl paper with a lower density and a lightweight property. By using polypropylene and polyester having different melting points, the pearl paper can have a low density and an advantage of possessing a lightweight property. Moreover, a dispersed phase part is formed from polyester having a relatively higher melting point and a continuous phase part is formed from polypropylene having a relatively lower melting point.

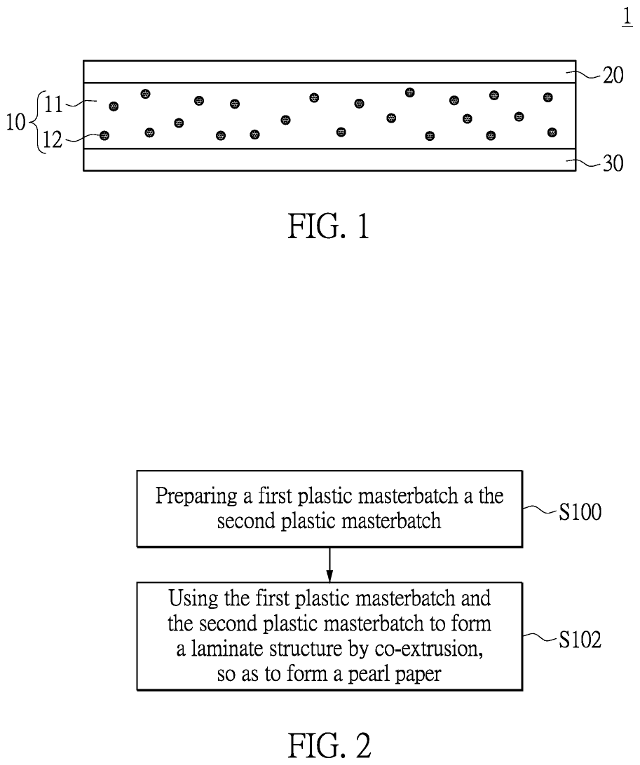

Referring to FIG. 1, FIG. 1 is a cross-sectional view of the pearl paper of the present disclosure. The pearl paper 1 of the present disclosure is a three-layered structure. The pearl paper 1 includes a lightweight layer 10, a first surface layer 20, and a second surface layer 30. The first surface layer 20 and the second surface layer 30 are respectively disposed on two opposite surfaces of the lightweight layer 10. The two surfaces of the lightweight layer 10 are respectively and completely covered by the first surface layer 20 and the second surface layer 30, so that the lightweight layer 10 is not exposed.

In comparison with a pearl paper on the market, the lightweight layer 10 of the present disclosure has a lower density (smaller than 0.65 g/cm³) so that the pearl paper 1 of the present disclosure can have the advantage of possessing the lightweight property. In the embodiment, the lightweight layer 10 includes a continuous phase part 11 and a dispersed phase part 12. The dispersed phase part 12 is uniformly dispersed in the continuous phase part 11, so that the pearl paper 1 has a uniform density. In a preferable embodiment, the dispersed phase part 12 dispersed in the continuous phase part 11 is formed in a spherical shape. The average size of the spherical shapes ranges from 1 μm to 2 μm. If the average size of the dispersed phase part 12 is too large, a rupture of membrane may occur during an extension process in manufacturing of the pearl paper 1. If the average size of the dispersed phase part 12 is too small, holes may not be formed during the extension process, and as a result, the pearl paper 1 may not possess the lightweight property.

Specifically, a material to form the continuous phase part 11 is polypropylene. The polypropylene can be a propylene homopolymer (PP-H), a propylene block copolymer (PP-B), a propylene random copolymer (PP-R), or a mixture thereof. In a preferable embodiment, the material to form the continuous phase part 11 is the propylene homopolymer and the melting point of the continuous phase part 11 ranges from 155° C. to 175° C. Specifically, a material to form the dispersed phase part 12 is polyester. For example, the polyester can be polyethylene terephthalate (PET), polybutylene terephthalate (PBT), or a mixture thereof.

In a preferable embodiment, the material to form the dispersed phase part 12 is polyethylene terephthalate, and the melting point of the dispersed phase part 12 ranges from 220° C. to 260° C.

A first plastic masterbatch containing polypropylene and polyester is provided. The first plastic masterbatch is used to form the lightweight layer 10. The first plastic masterbatch is prepared by fluxing a polypropylene resin granule and a polyester resin granule after adding an appropriate amount of a dispersant. For example, the dispersant can be a thermoplastic polyester elastomer (TPEE), but is not limited thereto. In the embodiment, the first plastic masterbatch includes 100 parts by weight of polypropylene and 20 to 60 parts by weight of polyester.

Apart from components mentioned above, a white pigment, an antistatic agent, inorganzic metal fillers, or a combination thereof can also be added in the fluxing process, so that the first plastic masterbatch can include the white pigment, the antistatic agent, inorganzic metal fillers, or a combination thereof.

For example, the pearl paper 1 can have an aesthetical appearance due to an addition of the white pigment. The white pigment can be, but not limited to, titanium dioxide. An addition of the antistatic agent can prevent static electricity from being generated during a membrane forming process and prevent a degradation of a quality of the pearl paper 1. The antistatic agent can be, but not limited to, polyethylene glycol fatty acid. In addition, the inorganic metal filler can also be added to form holes in the lightweight layer 10 in the extension process. The inorganic metal fillers can be, but not limited to, calcium carbonate or calcium silicate. In a preferable embodiment, the lightweight layer 10 is without the inorganic metal fillers. The weight of the inorganic metal fillers is heavier than propylene, so excluding the inorganic metal fillers can decrease the density of the pearl paper 1. However, the example illustrated above is only one of the available embodiments and should not be taken as limiting the scope of the present disclosure.

The melting point of the material of the dispersed phase part 12 (polyester resin granule) is higher than the melting point of the material of the continuous phase part 11 (polypropylene resin granule) by at least 20° C. in the present disclosure. Therefore, by adjusting a set temperature of a melting extruder machine, the polypropylene resin of the first plastic masterbatch can be melted to form the continuous phase part 11, and the polyester resin of the first plastic masterbatch can maintain its original shape to serve as the dispersed phase part 12. That is, the set temperature of the melting extruder machine is set up to be lower than the melting point of the polyester of the first plastic masterbatch (polyester resin granule) and higher than the melting point of the polypropylene of the first plastic masterbatch (polypropylene resin granule). Therefore, the polyester resin granule can be uniformly dispersed in polypropylene formed by polypropylene resin granule so as to form the lightweight layer 10 formed by the continuous phase part 11 and the dispersed phase part 12.

As mentioned above, the pearl paper 1 can have a lower density by blending polypropylene and polyester with different melting points rather than by adding the inorganic metal fillers. More specifically, in a conventional technology, the inorganic metal fillers can be calcium carbonate or calcium silicate. Generally, weights of metal elements are heavier than weights of organic elements. The addition of the inorganic metal fillers cannot decrease the density of the pearl paper 1. Therefore, by blending polypropylene and polyester with different melting points, the density of the pearl paper 1 can further be decreased.

The first surface layer 20 is disposed on one of the two surfaces of the lightweight layer 10, and the first surface layer 20 is a continuous layer. The term of “the continuous layer” means that the lightweight layer 10 is completely covered by the first surface layer 20 so that the lightweight layer 10 will not be exposed. If the lightweight layer 10 is not completely covered by the first surface layer 20, solvents used in a subsequent printed process may permeate into the holes of the lightweight layer 10, and as a result, a deformation of the pearl paper 1 and a degradation of the quality of the pearl paper 1 may occur. In addition, if the lightweight layer 10 is not completely covered by the first surface layer 20, the dispersed phase part 12 formed by the polyester resin granule may be separated from the continuous phase part 11 and dust may be produced after the pearl paper 1 is used for a long period of time. Dust will roughen the surface of the pearl paper 1 and lower the quality of the pearl paper 1.

Specifically, a material of the first surface layer 20 contains polypropylene and an anti-block agent. Usage of polypropylene enhances a compatibility between the first surface layer 20 and the lightweight layer 10 and a connecting force between the first surface layer 20 and the lightweight layer 10. An addition of the anti-block agent can prevent an adhesion from occurring during the membrane forming process (for manufacturing polypropylene membrane).

The second surface layer 30 is disposed on another surface of the two surfaces of the lightweight layer 10, and the second surface layer 30 is a continuous layer. The term of “the continuous layer” means that the lightweight layer 10 is completely covered by the second surface layer 30 so that the lightweight layer 10 will not be exposed. The effects of the second surface layer 30 are similar to the effects of the first surface layer 20. That is, the second surface layer 30 can prevent solvents from permeating into the lightweight layer 10 and prevent the dispersed phase part 12 from falling off from the continuous phase part 11, so that the quality of the pearl paper 1 can be enhanced.

Specifically, a material of the second surface layer 30 contains polypropylene, an anti-block agent, a white pigment, and a matte agent. Usage of polypropylene enhances a compatibility between the second surface layer 30 and the lightweight layer 10 and a connecting force between the second surface layer 30 and the lightweight layer 10. The addition of the anti-block agent can prevent an adhesion from occurring during the membrane forming process (for manufacturing polypropylene membrane). An appearance of the pearl paper 1 can be adjusted by the addition of the white pigment. The luster of the pearl paper 1 can be adjusted by the addition of the matte agent.

A second plastic masterbatch containing polypropylene is provided. The second plastic masterbatch is used to form the first surface layer 20 and the second surface layer 30. The second plastic masterbatch is prepared by fluxing a polypropylene resin granule with other components. Similarly, the second plastic masterbatch can contain other components, such as an anti-block agent, a white pigment, a matte agent, or a combination thereof.

In an embodiment, the second plastic masterbatch can be used to form the first surface layer 20. The second plastic masterbatch includes 100 parts by weight of polypropylene and 1 to 5 parts by weight of anti-block agent. Specifically, the polypropylene can be a propylene homopolymer, a propylene block copolymer, a propylene random copolymer, or a mixture thereof. In a preferable embodiment, the material to form the first surface layer 20 is the propylene homopolymer and the anti-block agent is silicon dioxide. However, the present disclosure is not limited thereto.

In another embodiment, the second plastic masterbatch can be used to form the second surface layer 30. The second plastic masterbatch includes 100 parts by weight of polypropylene, 1 to 5 parts by weight of the anti-block agent, 10 to 20 parts by weight of the white pigment, and 65 to 85 parts by weight of the matte agent. Specifically, the polypropylene can be a propylene homopolymer, a propylene block copolymer, a propylene random copolymer, or a mixture thereof. The matte agent can be an inorganic matte agent (such as silicon dioxide, kaolin, or diatomite) or an organic matte agent (such as wax or polyethylene). In a preferable embodiment, the material to form the second surface layer 30 is the propylene homopolymer, the anti-block agent is silicon dioxide, the white pigment is titanium dioxide, and the matte agent is polyethylene. However, the present disclosure is not limited thereto.

As mentioned above, the first surface layer 20 and the second surface layer 30 can be formed from the same or different materials according to requirements. In other words, both of the first surface layer 20 and the second surface layer 30 can be formed by a same kind of second plastic masterbatch. Or, the first surface layer 20 and the second surface layer 30 can respectively be formed by two different kinds of second plastic masterbatch.

In other embodiments, the pearl paper 1 of the present disclosure is not limited to being a three-layered structure only having the lightweight layer 10, the first surface layer 20, and the second surface layer 30. The pearl paper 1 can also be a three-layered structure having the lightweight layer 10 and two of the first surface layer 20. Also, the pearl paper 1 can also be a three-layered structure having a lightweight layer 10 and two of the second surface layer 30.

Referring to FIG. 2, FIG. 2 is a flowchart of the method for manufacturing the pearl paper of the present disclosure. First, the first plastic masterbatch and the second plastic masterbatch are prepared (step S100). The first plastic masterbatch and the second plastic masterbatch are respectively put in two different injection tanks. Then, the first plastic masterbatch and the second plastic masterbatch are used to form a laminate structure by co-extrusion, so as to form the pearl paper 1 (step S102). It should be noted that, in the laminate structure, the lightweight layer 10 formed by the first plastic masterbatch is disposed between the first surface layer 20 formed by the second plastic masterbatch and the second surface layer 30 formed by the second plastic masterbatch.

Further, a biaxial extension process or a uniaxial extension process can be performed to adjust a thickness or a dimension of the laminate structure, so as to form the lightweight layer 10 meeting expected standards. In a biaxial extension process or a uniaxial extension process, the laminate structure will be stretched. When the continuous phase part 11 is stretched, some holes are formed between the continuous phase part 11 and the dispersed phase part 12 due to the irregular shapes of the dispersed phase part 12. Therefore, the density of the lightweight layer 10 is decreased.

After the extension process, a thickness of the laminate structure (the pearl paper 1) is adjusted. In a preferable embodiment, a thickness of the lightweight layer 10 ranges from 70 μm to 100 μm, a thickness of the first surface layer 20 ranges from 5 μm to 10 μm, and a thickness of the second surface layer 30 ranges from 5 μm to 10 μm. In other words, a ratio of the thickness of the lightweight layer 10 to the first surface layer 20 ranges from 7 to 20 and a ratio of the thickness of the lightweight layer 10 to the second surface layer 30 ranges from 7 to 20. Therefore, the first surface layer 20 and the second surface layer 30 can prevent the lightweight layer 10 from being exposed. Solvents can be prevented from permeating into the lightweight layer 10, and the dispersed phase part 12 can be prevented from falling off from the continuous phase part 11, so that the quality of the pearl paper 1 can be enhanced. In addition, when the pearl paper 1 has the specific thickness mentioned above, the pearl paper 1 can have good mechanical property so as to endure external force.

In a preferable embodiment, after an extension process, a density of the laminate structure (the pearl paper 1) ranges from 0.4 g/cm³ to 0.6 g/cm³. In comparison with the pearl paper on the market, the pearl paper 1 of the present disclosure has a lower density and has the advantage of possessing the lightweight property. Preferably, the density of the pearl paper 1 of the present disclosure ranges from 0.4 g/cm³ to 0.5 g/cm³.

To compare the pearl paper 1 of the present disclosure (Example 1) with the pearl paper on the market (Comparative Example 1), two different pearl papers are prepared. Components of the two different pearl papers are listed in Table 1 and properties of the two different pearl papers are listed in Table 2.

TABLE 1
Components of the pearl papers of Example
1 (E1) and Comparative Example 1 (C1)

| Components (parts by weight) | | E1 | C1 |
|---|---|---|---|
| First surface | polypropylene | 100 | 100 |
| layer 20 | anti-block agent (silicon dioxide) | 3 | 3 |
| Lightweight | polypropylene | 100 | 100 |
| layer 10 | polyester (PET) | 5 | 0 |
| | white pigment (titanium dioxide) | 6 | 7 |
| | inorganic metal filler (calcium carbonate) | 0 | 28 |
| | antistatic agent (polyethylene glycol | 3 | 3 |
| | fatty acid) | | |
| Second surface | polypropylene | 35 | 35 |
| layer 30 | matte agent | 80 | 80 |
| | white pigment (titanium dioxide) | 10 | 10 |
| | anti-block agent (silicon dioxide) | 4 | 4 |

TABLE 2
Properties of the pearl papers of Example
1 (E1) and Comparative Example 1 (C1)

| Properties | | E1 | C1 |
|---|---|---|---|
| Thickness (μm) | | 120 | 120 |
| Density (g/cm³) | | 0.50 | 0.65 |
| Tensile strength (MPa) | MD direction | 67 | 64 |
| | CD direction | 118 | 112 |
| Elongation percent (%) | MD direction | 100 | 104 |
| | CD direction | 22 | 22 |
| Tearing strength (MPa) | MD direction | 6.2 | 6.5 |
| | CD direction | 9.1 | 8.9 |

According to results of Table 1 and Table 2, due to the properties of the lightweight layer 10 included in the pearl paper 1, the pearl paper 1 of the present disclosure has a low density (0.4 g/cm³ to 0.6 g/cm³), even without calcium carbonate. Therefore, the pearl paper 1 has the lightweight property.

In addition, in terms of mechanical properties, the pearl paper 1 of the present disclosure has a tensile strength along machine direction (MD) ranging from 65 MPa to 75 MPa and has a tensile strength along cross direction (CD) ranging from 110 MPa to 130 MPa. The pearl paper 1 of the present disclosure has an elongation percent along machine direction (MD) ranging from 90% to 110% and has an elongation percent along cross direction (CD) ranging from 20% to 30%. The pearl paper 1 of the present disclosure has a tearing strength along machine direction (MD) ranging from 6.0 MPa to 8.0 MPa and has a tearing strength along cross direction (CD) ranging from 8.5 MPa to 10.5 MPa. According to Table 2, the pearl paper 1 of the present disclosure has the similar mechanical properties to the conventional pearl paper and has a lower density than the conventional pearl paper.

In conclusion, the pearl paper 1 and the method for manufacturing the same provided by the present disclosure have technical features of “the lightweight layer 10 includes a continuous phase part 11 and a dispersed phase part 12”, “the material of the continuous phase part 11 contains polypropylene”, and “the material of the dispersed phase part 12 contains polyester”, so as to decrease a density of the pearl paper 1 for possessing a lightweight property.

Further, the pearl paper 1 and the method for manufacturing the same provided by the present disclosure have technical features of “the melting point of the material of the dispersed phase part 12 is higher than the melting point of the material of the continuous phase part 11 by at least 20° C.”, so as to uniformly disperse the dispersed phase part 12 in the continuous phase part 11.

Further, the pearl paper 1 and the method for manufacturing the same provided by the present disclosure have technical features of “the ratio of the thickness of the lightweight layer 10 to a thickness of the first surface layer 20 is 7 to 20” and “the ratio of the thickness of the lightweight layer 10 to a thickness of the second surface layer 30 is 7 to 20”, so as to prevent the lightweight layer 10 from being exposed.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A pearl paper, comprising:
a first surface layer which is a polypropylene layer;
a second surface layer disposed on the first surface layer, the second surface layer being a polypropylene layer; and
a lightweight layer disposed between the first surface layer and the second surface layer; wherein the lightweight layer includes a continuous phase part and a dispersed phase part, a material of the continuous phase part contains polypropylene, and a material of the dispersed phase part contains polyester.

2. The pearl paper according to claim 1, wherein the lightweight layer includes 100 parts by weight of polypropylene and 3 to 15 parts by weight of polyester.

3. The pearl paper according to claim 1, wherein a melting point of the material of the dispersed phase part is higher than a melting point of the material of the continuous phase part by at least 20° C.

4. The pearl paper according to claim 1, wherein a ratio of a thickness of the lightweight layer to a thickness of the first surface layer is 7 to 20, and a ratio of the thickness of the lightweight layer to a thickness of the second surface layer is 7 to 20.

5. The pearl paper according to claim 1, wherein a density of the pearl paper ranges from 0.4 g/cm³ to 0.6 g/cm³.

6. The pearl paper according to claim 1, wherein a thickness of the first surface layer ranges from 5 μm to 10 μm, and a thickness of the second surface layer ranges from 5 μm to 10 μm.

7. The pearl paper according to claim 1, wherein a thickness of the lightweight layer ranges from 70 μm to 100 μm.

8. The pearl paper according to claim 1, wherein the first surface layer includes 100 parts by weight of polypropylene and 1 to 5 parts by weight of an anti-block agent.

9. The pearl paper according to claim 1, wherein the second surface layer includes 35 parts by weight of polypropylene, 1 to 5 parts by weight of an anti-block agent, 10 to 20 parts by weight of a white pigment, and 65 to 85 parts by weight of a matte agent.

10. The pearl paper according to claim 1, wherein the pearl paper has a tearing strength of 6.0 MPa to 8.0 MPa along a machine direction and a tearing strength of 8.5 MPa to 10.5 MPa along a cross direction.

11. The pearl paper according to claim 1, wherein the pearl paper has a tensile strength of 65 MPa to 75 MPa along a machine direction and a tensile strength of 110 MPa to 130 MPa along a cross direction.

12. The pearl paper according to claim 1, wherein the pearl paper has an elongation percent of 90% to 110% along a machine direction and an elongation percent of 20% to 30% along a cross direction.

13. The pearl paper according to claim 1, wherein an average size of the dispersed phase part ranges from 1 μm to 2 μm.

14. A method for manufacturing a pearl paper, comprising steps of:
providing a first plastic masterbatch and a second plastic masterbatch; wherein the first plastic masterbatch includes polypropylene and polyester, and the second plastic masterbatch includes polypropylene; and
using the first plastic masterbatch and the second plastic masterbatch to form a laminate structure by co-extrusion;
wherein the laminate structure includes a first surface layer, a second surface layer, and a lightweight layer disposed between the first surface layer and the second surface layer, and wherein the lightweight layer is formed from the first plastic masterbatch, the lightweight layer includes a continuous phase part and a dispersed phase part, a material of the continuous phase part includes polypropylene, a material of the dispersed phase part includes polyester, and the first surface layer and the second surface layer is formed from the second plastic masterbatch.

15. The method according to claim 14, wherein the lightweight layer is free of inorganic metal fillers.
